(19) United States
(12) Patent Application Publication
(10) Pub. No.: US 2026/0186618 A1
(43) Pub. Date: Jul. 2, 2026

(54) ELECTRONIC DEVICE AND CURSOR DISPLAY CONTROL METHOD THEREOF

(71) Applicant: ASUSTeK COMPUTER INC., Taipei City (TW)

(72) Inventors: Wen-Yun Liu, Taipei City (TW); Yi-Fang Chiang, Taipei City (TW); Ya-Ting Chen, Taipei City (TW)

(73) Assignee: ASUSTeK COMPUTER INC., Taipei City (TW)

(21) Appl. No.: 19/052,300

(22) Filed: Feb. 13, 2025

(30) Foreign Application Priority Data
Dec. 26, 2024 (TW) 113151006

(51) Int. Cl. G06F 3/04812; G06F 3/033

(52) U.S. Cl. CPC G06F 3/04812; G06F 3/033

(57) ABSTRACT

Provided are an electronic device with a cursor display control method and the cursor display control method. The cursor display control method includes the following. In response to the movement of an operating device, display information of a display device is obtained. A cursor speed is calculated based on the display information. A cursor displayed on the display device is caused to move according to the cursor speed.

### CROSS-REFERENCE TO RELATED APPLICATION

This application claims the priority benefit of Taiwan application serial no. 113151006, filed on Dec. 26, 2024. The entirety of the above-mentioned patent application is hereby incorporated by reference herein and made a part of this specification.

### BACKGROUND

### Technical Field

The disclosure relates to an electronic device and method, and particularly relates to an electronic device with a cursor display control method and the cursor display control method.

### Related Art

In recent years, although the hardware performance of electronic devices such as laptop computers has significantly improved, the original system settings have not shown improvement in terms of control and response efficiency between operation input and display output, thereby failing to enhance user experience.

In the existing technology, if users want to improve their usage experience, the users usually need to search for and manually adjust relevant settings in the operating system, or purchase additional specialized operating devices, causing inconvenience in use.

### SUMMARY

In view of the above, the disclosure provides an electronic device with a cursor display control method and the cursor display control method. The cursor display control method includes the following. In response to the movement of an operating device, display information of a display device is obtained. A cursor speed is calculated based on the display information. A cursor displayed on the display device is caused to move according to the cursor speed.

An electronic device of the disclosure includes an operating device, a display device, a storage medium, and a processor. The operating device is used to operate the electronic device. The display device is used to display a cursor corresponding to the operating device. The storage medium is used to store a program. The processor is coupled to the operating device, the display device, and the storage medium. The processor is configured to execute the program to perform the following operations. In response to the movement of the operating device, the display information of the display device is obtained. The cursor speed is calculated based on the display information. The cursor displayed on the display device is caused to move according to the cursor speed.

Based on the above, the electronic device with the cursor display control method and the cursor display control method of the disclosure can automatically calculate corresponding cursor speed values for the display information of actual specifications and logical specifications of the display device, without requiring manual settings by the user. Thereby, the disclosure can allow users to experience better control and feedback, thus improving the usability and productivity of the electronic device.

### BRIEF DESCRIPTION OF THE DRAWINGS

FIG. 1 is a schematic diagram showing an electronic device with a cursor display control method according to an embodiment of the disclosure.

FIG. 2 is a flowchart showing the cursor display control method according to an embodiment of the disclosure.

FIG. 3A to FIG. 3F show the relationships between C/R ratio and various display information according to an embodiment of the disclosure.

FIG. 4 is a flowchart showing the cursor display control method according to an embodiment of the disclosure.

### DESCRIPTION OF THE EMBODIMENTS

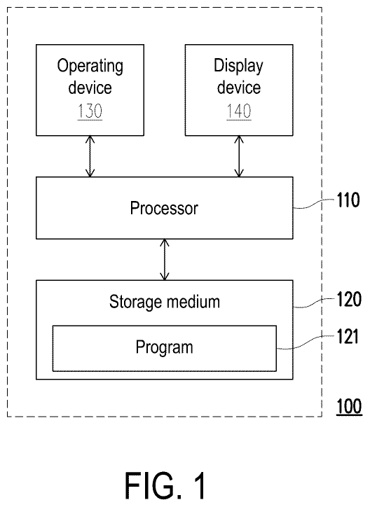

FIG. 1 is a schematic diagram showing an electronic device 100 with a cursor display control method according to an embodiment of the disclosure. In this embodiment, the electronic device 100 includes a processor 110, a storage medium 120, an operating device 130, and a display device 140. The processor 110 is coupled to the storage medium 120, the operating device 130, and the display device 140.

In an embodiment, the electronic device 100 is a laptop computer, a personal computer, a smart tablet, or other similar devices, but the disclosure is not limited thereto. The processor 110 is a central processing unit, or other programmable general-purpose or special-purpose microprocessors, a digital signal processor, a programmable controller, an application-specific integrated circuit, or other similar components or a combination of the above components.

The storage medium 120 is used to store various software, data, and program codes required for the operation of the electronic device 100. In an embodiment, the storage medium 120 is a non-transient fixed or removable random access memory, a read-only memory, a flash memory, a hard disk, a solid-state drive, or other similar components, or a combination of the above components. In this embodiment, the storage medium 120 stores a cursor speed adaptive program 121 (hereinafter referred to as the program 121).

The operating device 130 used to operate the electronic device 100 may be, for example, a touchpad, a wireless/wired mouse, a trackball, or other similar devices, but the disclosure is not limited thereto. The display device 140 used to display the cursor corresponding to the operating device 130 may be, for example, a liquid crystal display (LCD) and displays that provide display functions using cold cathode fluorescent lamp (CCFL) or light-emitting diode (LED) as backlight devices, but the disclosure is not limited thereto. In this embodiment, the display device 140 may include, for example, one display.

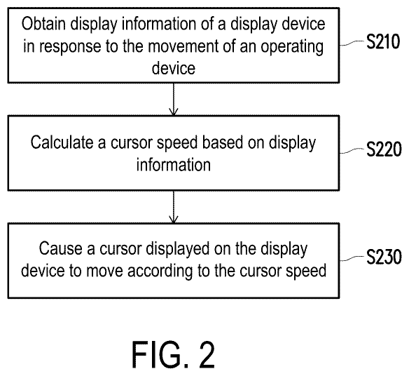

FIG. 2 is a flowchart showing the cursor display control method according to an embodiment of the disclosure, in which the cursor display control method may be implemented by the processor 110 of the electronic device 100 in FIG. 1 through executing the program 121.

In Step S210, in response to the movement of the operating device 130, the processor 110 of the electronic device 100 obtains display information of the display device 140.

For example, the display information of the display device 140 includes display size information, display resolution information, dpi (dots per inch) information, and report rate information. The display size information indicates the length of the diagonal of the display of the display device 140, usually measured in inches. The display resolution information includes horizontal resolution information and vertical resolution information. The horizontal resolution information indicates the quantity of pixels displayed in the horizontal direction on the display of the display device 140, while the vertical resolution information indicates the quantity of pixels displayed in the vertical direction on the display of the display device 140. The dpi information indicates the quantity of pixels presented per inch of display area on the display of the display device 140. The report rate information indicates the number of times the display screen is refreshed per second on the display of the display device 140.

In Step S220, the processor 110 calculates the cursor speed based on the display information. In this embodiment, the processor 110 may execute Formula (1) as follows to obtain the cursor speed.

$$CS = K \times \frac{DRX}{DS \times DPI \times RR} \qquad ( 1 )$$

In Formula (1), the processor 110 calculates the cursor speed (CS) based on the display size information (DS), the horizontal resolution information (DRX), the dpi information (DPI), and the report rate information (RR) of the display information. The cursor speed is proportional to the display resolution information, and inversely proportional to the display size information, the dpi information, and the report rate information, where K is a constant.

Referring to Formula (2) as follows, the C/R ratio represents the ratio of a movement of control of the movement generated when the operating device 130 is controlled to a movement of cursor of the movement displayed by the cursor on the display device 140. Under the same movement of control, a higher C/R ratio value indicates a larger movement of the cursor.

$$C / R ratio = \frac{movement of cursor}{movement of control} \qquad ( 2 )$$

For example, if a touchpad is used as the operating device 130, the movement of control corresponds to the trajectory and speed of the finger of the user or a stylus on the touchpad. If a mouse is used as the operating device 130, then the movement of control corresponds to the actual trajectory and speed of the hand of the user moving the mouse. If a trackball is used as the operating device 130, then the movement of control corresponds to the trajectory and speed of the trackball detected by a sensor.

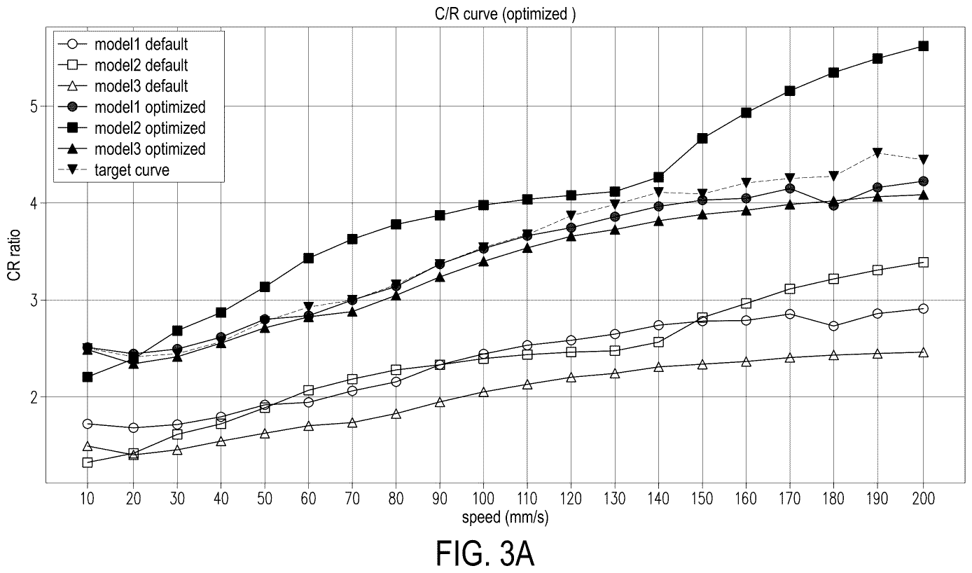

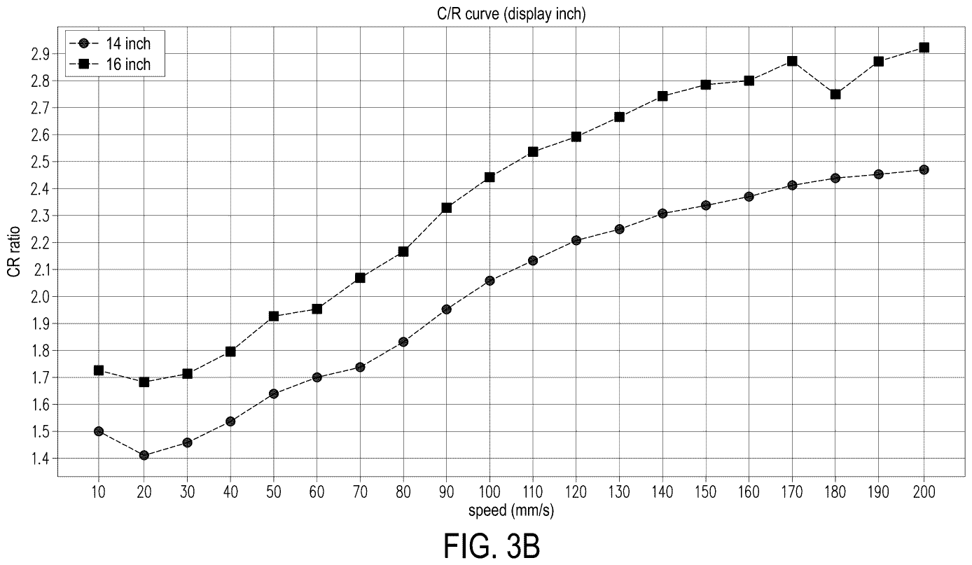

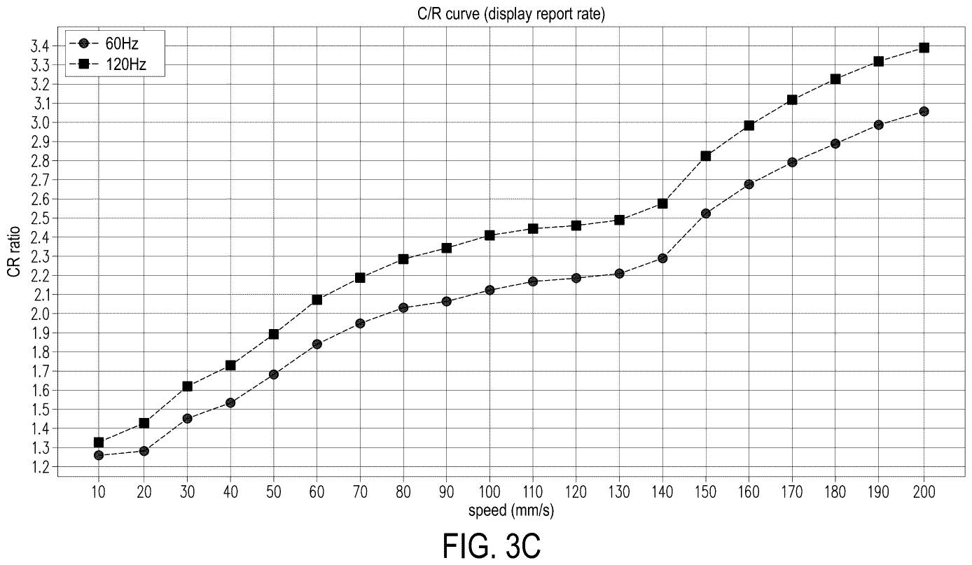

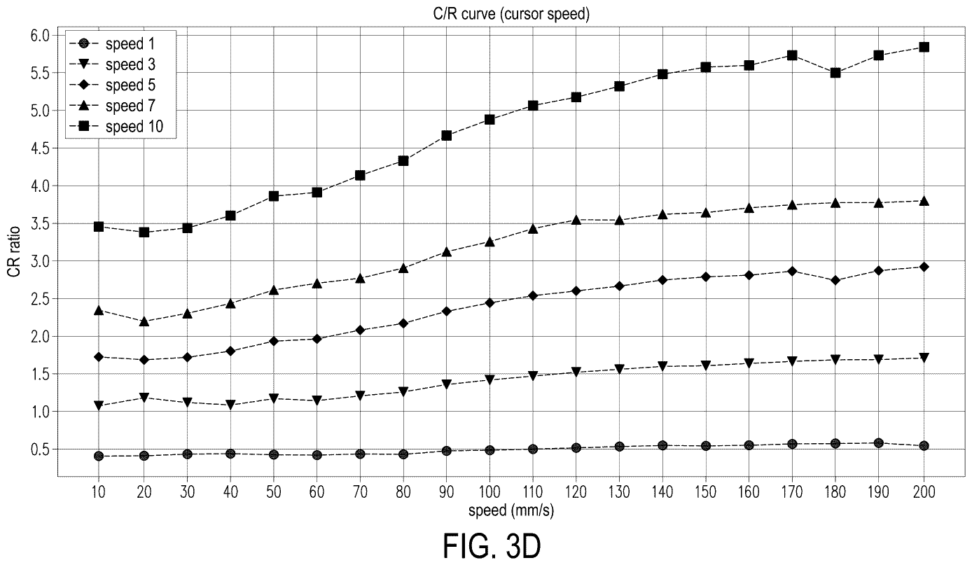

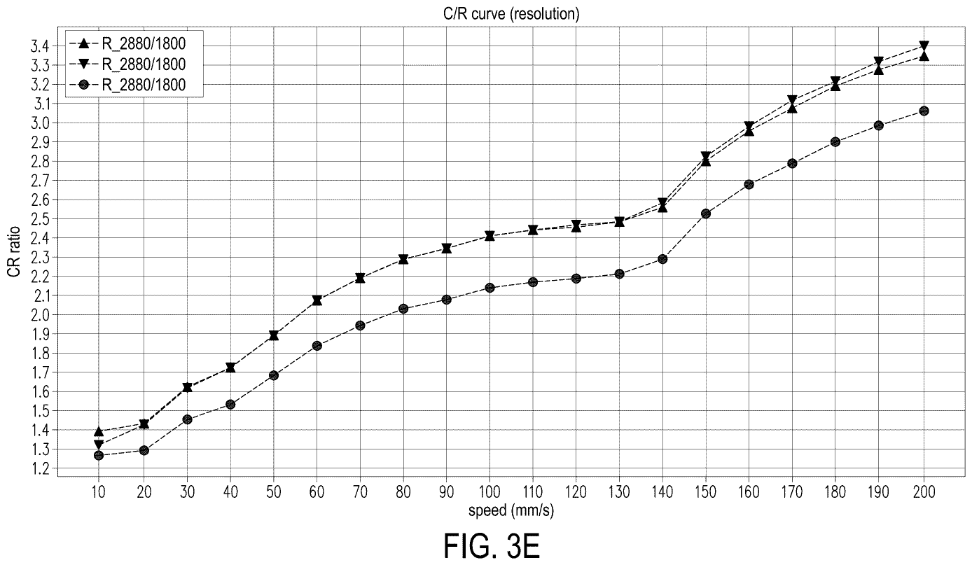

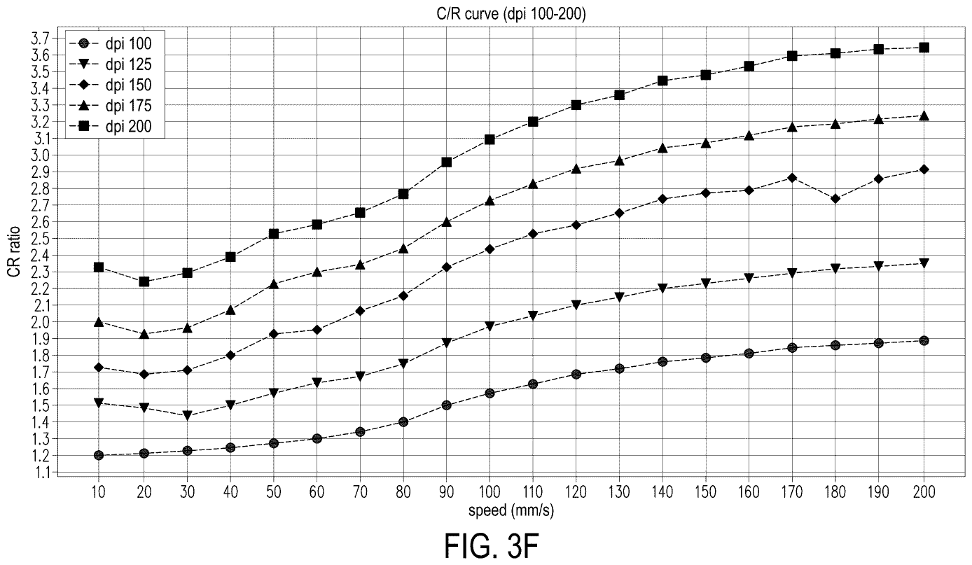

Please refer to FIG. 3A to FIG. 3F, which show the relationships between the C/R ratio and various display information according to an embodiment of the disclosure. Through experiments, the disclosure identifies a target C/R curve with the best user experience, which is the curve marked with the dotted line in FIG. 3A. On the other hand, the constant K in Formula (1) above may be derived through the relationship between the display size information and C/R ratio in FIG. 3B, the relationship between the report rate information and C/R ratio in FIG. 3C, the relationship between the cursor speed and C/R ratio in FIG. 3D, the relationship between the display resolution information and C/R ratio in FIG. 3E, and the relationship between the dpi information and C/R ratio in FIG. 3F, thereby deriving Formula (3) as follows.

$$CS = 7 \times \frac{14}{DS} \times \frac{DRX}{2880} \times \frac{200}{DPI} \qquad ( 3 )$$

Formula (3) illustrates an example of calculating the cursor speed based on the display size information (DS), the horizontal resolution information (DRX), the dpi information (DPI), and the derived constant K, but the disclosure is not limited thereto. For instance, according to Formula (1), Formula (3) may be modified to include the report rate information (RR) for calculating the cursor speed. In Formula (3), after inputting the display information of the target display of the display device 140, the cursor speed (CS) that can be close to the target C/R curve on the target display may be calculated. Referring to FIG. 3A, the curves of modes 1 to 3 correspond to different display information under different display settings. The curves of modes 1 to 3 marked with hollow circles, hollow squares, and hollow triangles respectively represent the C/R curves before adjusting the cursor speed using Formula (3). The curves of modes 1 to 3 marked with solid circles, solid squares, and solid triangles respectively represent the C/R curves after adjusting the cursor speed using Formula (3). From FIG. 3A, it may be seen that the C/R curves after adjusting the cursor speed can be closer to the target C/R curve, thereby improving the user experience. Here, the C/R curve represents the trend of the ratio between the movement of control of the movement generated when the operating device 130 is controlled and the movement of cursor of the movement displayed by the cursor on the display device 140 at different cursor speeds.

In Step S230, the cursor displayed on the display device 140 is caused to move according to the cursor speed. Thereby, the movement of control generated when the operating device 130 is controlled and the movement of cursor displayed by the cursor on the display device 140 can be close to the target C/R curve, allowing the user to experience better control and feedback.

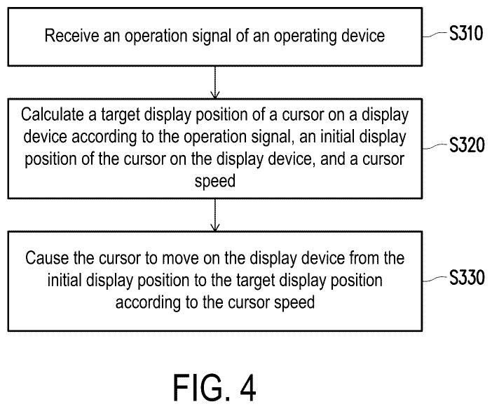

Please refer to FIG. 4, which shows a flowchart of the cursor display control method according to an embodiment of the disclosure.

In Step S310, an operation signal of the operating device 130 is received. Specifically, when being controlled, the operating device 130 generates the operation signal, and the processor 110 of the electronic device 100 may receive the operation signal.

In Step S320, a target display position of the cursor on the display device 140 is calculated according to the operation signal, an initial display position of the cursor on the display device 140, and the cursor speed. Specifically, the processor 110 may determine the movement of control generated when the operating device 130 is controlled according to the operation signal received. Then, the processor 110 may calculate the target display position of the cursor on the display device 140 according to the movement of control, the initial display position of the cursor on the display device 140 when the operation signal is received, and the cursor speed calculated in Step S220.

In Step S330, the cursor is caused to move on the display device 140 from the initial display position to the target display position according to the cursor speed. Specifically, the processor 110 causes the cursor to move based on the trajectory represented by the movement of control and the cursor speed calculated. Thereby, the movement of control generated when the user controls the operating device 130 can be precisely reflected in the movement of cursor displayed on the display device 140.

In an embodiment of the disclosure, the processor 110 may sequentially execute Step S310 to receive the operation signal, then determine the movement of the operating device 130. Next, Step S210 and Step S220 are executed to obtain the display information and the cursor speed. Then, Step S320 and Step S330 are executed to achieve the result of moving the cursor displayed on the display device 140 according to the cursor speed.

In an embodiment, the electronic device 100 may execute Step S210 and Step S220 to obtain the display information and cursor speed in advance during manufacturing. The processor 110 may sequentially execute Step S310 to Step S330 after the user controls the operating device 130 to generate the operation signal, thereby achieving the result of moving the cursor displayed on the display device 140 according to the cursor speed.

In an embodiment, the processor 110 may monitor whether the display information of the display device 140 is changed by executing the program 121. In response to detecting that the display information is changed, the processor recalculates the cursor speed based on the changed display information. In this case, the processor 110 may calculate a new target display position of the cursor on the display device 140 according to the recalculated cursor speed.

In an embodiment, the display device 140 of the electronic device 100 in FIG. 1 may include a first display and a second display for displaying multiple display screens. For example, after receiving the operation signal from the operating device 130, the processor 110 may determine that the cursor will move from the display range of one of the first display and the second display to the display range of the other of the first display and the second display. Then, in response to the movement of the operating device 130, the processor 110 may obtain first display information of the first display and second display information of the second display; calculate a first cursor speed and a second cursor speed based on the first display information and the second display information; and cause the cursor to move in the display range of the first display according to the first cursor speed, and cause the cursor to move in the display range of the second display according to the second cursor speed.

As mentioned above, the processor 110 may determine the movement of control generated when the operating device 130 is controlled according to the received operation signal. Then, the processor 110 may calculate the target display position of the cursor on one of the first display and the second display, as well as the initial display position and target display position of the cursor on the other of the first display and the second display, according to the movement of control, the initial display position of the cursor on one of the first display and the second display when the operation signal is received, and the calculated first cursor speed and second cursor speed. Therefore, the processor 110 may move the cursor within the display range of the first display according to the first cursor speed, and move the cursor within the display range of the second display according to the second cursor speed. Thereby, the movement of control generated when the user controls the operating device 130 can be precisely reflected in the movement of cursor from the display range of one of the first display and the second display to the display range of the other of the first display and the second display.

In summary, the electronic device with the cursor display control method and the cursor display control method of the disclosure can automatically calculate corresponding cursor speed values for the display information of actual specifications and logical specifications of the display device, without requiring manual settings by the user. Thereby, the disclosure can allow users to experience better control and feedback, thus improving the usability and productivity of the electronic device.

1. A cursor display control method, adapted to an electronic device, wherein the electronic device comprises an operating device and a display device, the display device displays a cursor corresponding to the operating device, a movement of the cursor corresponds to a movement of the operating device, and the cursor display control method comprising:
obtaining display information of the display device in response to the movement of the operating device, wherein the display information comprises display size information, display resolution information, and dpi information;
calculating a cursor speed based on the display information, wherein the cursor speed is adjusted according to the display information of the display device; and
causing the cursor displayed on the display device to move according to the cursor speed.

2. The cursor display control method as claimed in claim 1, further comprising:
receiving an operation signal of the operating device;
calculating a target display position of the cursor on the display device according to the operation signal, an initial display position of the cursor on the display device, and the cursor speed; and
causing the cursor to move on the display device from the initial display position to the target display position according to the cursor speed.

3. The cursor display control method as claimed in claim 1, wherein the display information further comprises report rate information.

4. The cursor display control method as claimed in claim 3, wherein the cursor speed is proportional to the display resolution information, and the cursor speed is inversely proportional to the display size information, the dpi information, and the report rate information.

5. The cursor display control method as claimed in claim 1, further comprising recalculating the cursor speed based on changed display information in response to detecting that the display information is changed.

6. The cursor display control method as claimed in claim 1, wherein the display device comprises a first display and a second display, and the cursor display control method further comprises:
obtaining first display information of the first display and second display information of the second display in response to the movement of the operating device;
calculating a first cursor speed and a second cursor speed based on the first display information and the second display information; and
causing the cursor to move in a display range of the first display according to the first cursor speed, and causing the cursor to move in a display range of the second display according to the second cursor speed.

7. An electronic device with a cursor display control method, comprising:
an operating device adapted to operate the electronic device;
a display device for displaying a cursor corresponding to the operating device, wherein a movement of the cursor corresponds to a movement of the operating device;
a storage medium for storing a program; and
a processor coupled to the operating device, the display device, and the storage medium, and configured to execute the program to:
obtain display information of the display device in response to the movement of the operating device, wherein the display information comprises display size information, display resolution information, and dpi information;
calculate a cursor speed based on the display information, wherein the cursor speed is adjusted according to the display information of the display device; and
cause the cursor displayed on the display device to move according to the cursor speed.

8. The electronic device as claimed in claim 7, wherein the processor is further configured to:
receive an operation signal of the operating device;
calculate a target display position of the cursor on the display device according to the operation signal, an initial display position of the cursor on the display device, and the cursor speed; and
cause the cursor to move on the display device from the initial display position to the target display position according to the cursor speed.

9. The electronic device as claimed in claim 7, wherein the display device comprises a first display and a second display, and the processor is further configured to:
obtain first display information of the first display and second display information of the second display in response to the movement of the operating device;
calculate a first cursor speed and a second cursor speed based on the first display information and the second display information; and
cause the cursor to move in a display range of the first display according to the first cursor speed, and cause the cursor to move in a display range of the second display according to the second cursor speed.
